(19) United States
(12) Patent Application Publication
(10) Pub. No.: US 2019/0171687 A1
(43) Pub. Date: Jun. 6, 2019

(54) LIVE SOCIAL MEDIA BUSINESS SEARCH SYSTEM

(71) Applicant: Justin Caterbone, Norristown, PA (US)

(72) Inventor: Justin Caterbone, Norristown, PA (US)

(21) Appl. No.: 16/210,873

(22) Filed: Dec. 5, 2018

Related U.S. Application Data
(60) Provisional application No. 62/595,046, filed on Dec. 5, 2017.

(51) Int. Cl. G06F 16/9536; G06F 16/9535; H04W 4/021; G06Q 50/00

(52) U.S. Cl. CPC G06F 16/9536; G06Q 50/01; H04W 4/021; G06F 16/9535

(57) ABSTRACT

A social network system and method; the social network system includes a server having a processor, a memory and a database; and a software application downloadable to an electronic device such as a smartphone, a tablet computer, a desktop computer, etc. The social network system is used to provide a means of allowing a user to search for a business and receive real-time feedback about the businesses they are searching for.

### CROSS REFERENCE TO RELATED APPLICATION

The present application is related to and claims priority to U.S. Provisional Patent Application No. 62/595,046 filed Dec. 5, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of business searching and more specifically relates to business searching utilizing social methods to provide instant live feedback.

### 2. DESCRIPTION OF RELATED ART

Various methods exist for business searching, but these methods often contain conflicting information, or the information may not be relevant depending on the person doing the search. Additionally, the methods can often contain outdated information that may not apply or may be misleading to the current status of the business.

Though the internet is widely available on the smart phones of today, it can be ‘clunky’ and run slowly as many websites are not optimized for use on a smart phone. This short-coming can often mean the difference between a business reaching or not reaching a potential customer looking for a particular service, especially if the individual searching for a business is not in their own town, but on vacation and does not have ready access to a computer other than their smart phone. Thus, a suitable solution is desired.

U.S. Pat. No. 8,560,390 to Christopher William Higgins relates to a method and apparatus for social network marketing with brand referral. The described method and apparatus for social network marketing with brand referral includes a service provider that facilitates consumption of goods, brands, or services on an interactive network using characterizations of consumers, behavior, brands, consumable goods, advertisers, and advocates to determine a three-way match between a consumable good, a consumer, and an advocate. The matching method determines one or more goods likely to be benefit from the marketing scheme by maximizing the estimated contextual value of personalized advocacy. Further, the service provider captures the value of the personalized advocacy in each match and distributes that value in the form of various marketing incentives.

### BRIEF SUMMARY OF THE INVENTION

In view of the foregoing disadvantages inherent in the known business searching art, the present disclosure provides a novel live social media business search system. The general purpose of the present disclosure, which will be described subsequently in greater detail, is to provide a means of allowing a user to search for a business and receive real-time feedback about the businesses they are searching for.

A social network system and method is disclosed herein. The social network system and method includes at least one server which may have a processor and a memory, the memory may include a database storing a plurality of user-profiles and a plurality of merchant-profiles. The memory further may include computer readable instructions executable by the processor that when executed by the processor trigger the processor to: receive a merchant search request via the software application; determine a location of a user of the software application via the global positioning means of the electronic-device; determine nearby merchants from the plurality of merchant-profiles based on the location of the user and generate a list of nearby merchant-profiles, each of the nearby merchants being associated with a geofence threshold; determine nearby users from the plurality of user-profiles that are located within the geofence threshold for each of the nearby merchants and generate at least one list of nearby user-profiles. Further, a software application may be provided which may be downloadable to an electronic-device, the electronic-device being equipped with global positioning means.

A method of using the social network system and method is also disclosed herein. The method of using social network system and method may comprise the steps of: providing the social network system as above; receiving a merchant search request via the software application; determining a location of a user of the software application via the global positioning means read by the electronic-device; determining nearby merchants from the plurality of merchant-profiles based on the location of the user and generating a list of nearby merchant-profiles, each of the nearby merchants being associated with a geofence threshold; determining nearby users from the plurality of user-profiles that are located within the geofence threshold for each of the nearby merchants and generating at least one list of nearby user-profiles.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a live social media business search system, constructed and operative according to the teachings of the present disclosure.

FIG. 1 is a front perspective view of the social network system and method during an ‘in-use’ condition, according to an embodiment of the disclosure.

FIG. 2 is a front perspective view of the social network system and method of FIG. 1, according to an embodiment of the present disclosure.

FIG. 3A is a front perspective view of the social network system and method of FIG. 1, according to an embodiment of the present disclosure.

FIG. 3B is a front perspective view of the social network system and method of FIG. 1, according to an embodiment of the present disclosure.

FIG. 3C is a front perspective view of the social network system and method of FIG. 1, according to an embodiment of the present disclosure.

FIG. 3D is a front perspective view of the social network system and method of FIG. 1, according to an embodiment of the present disclosure.

FIG. 4 is a front perspective view of the social network system and method of FIG. 1, according to an embodiment of the present disclosure.

FIG. 5 is a flow diagram illustrating a method of use for the social network system and method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to business searching and more particularly to a live social media business search system as used to improve the business searching utilizing social methods to provide instant live feedback.

Generally disclosed is a system comprised of several interface menus that allow for easy access to searching functions for local businesses. After registering an account, a user may search for different businesses and see location, people at the location, live video feeds of the business and a demographic chart. The demographic chart may show if other people at the business are in their same age range or other grouping. Users may be automatically checked into an establishment via geofencing. Users may also be able to see current events happening at the businesses they search for, saving users time and energy to find local businesses.

The demographic information feedback may help users choose the business that best suits their needs. When searching for a business, the user may see a demographic view (based on user profiles) of clientele currently at a business as well as limited profile info about clientele based on profile settings of the users being viewed. The consumer aspect will also show “hotspots” based on a business's percentage of capacity, allowing the user to seek out an atmosphere of their preference. Lastly, the consumer aspect will allow users to “create an event” such as a reunion and send an invitation for either current or future events.

The system may provide an ability to advertise and promote a business for merchant for business owners, allowing business owners to benefit from the system also.

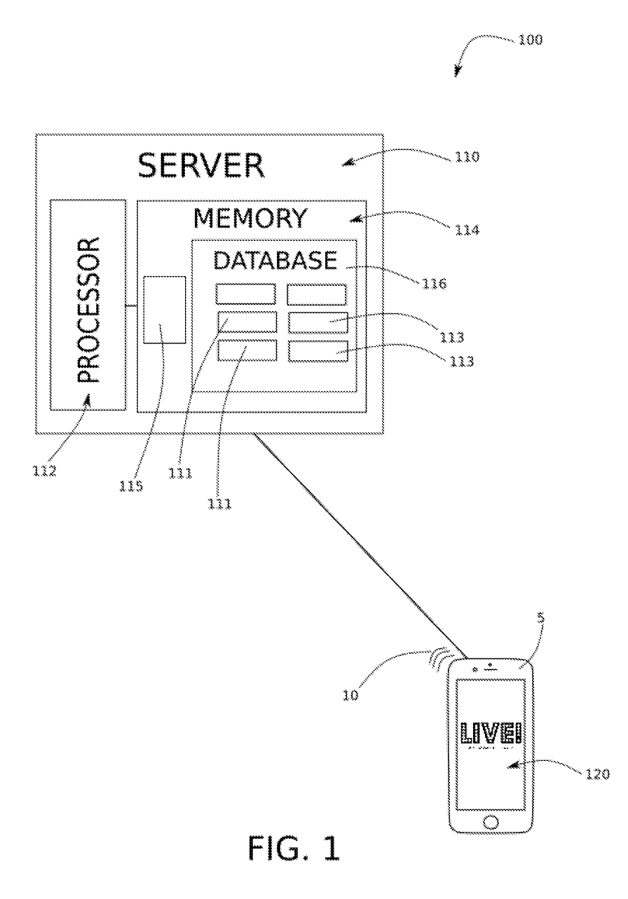

Referring now more specifically to the drawings by numerals of reference, there is shown in FIGS. 1-5, various views of a social network system 100 and method 500.

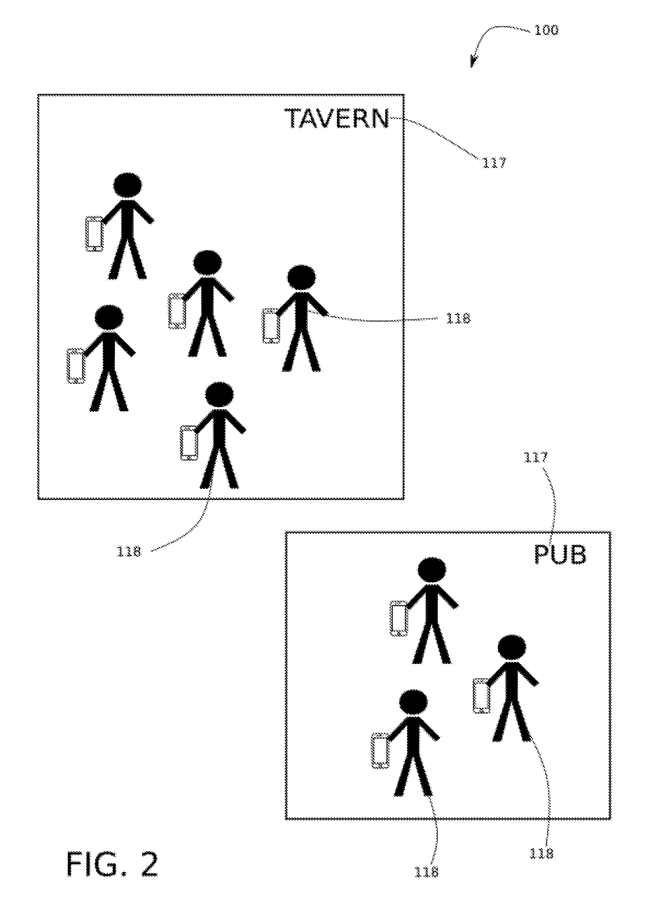

FIGS. 1-2 show a social network system and method 100 during an ‘in-use’ condition 150, according to an embodiment of the present disclosure. The social network system 100 may be used for facilitating merchant searching and gaining live feedback. As illustrated, the social network system 100 may include at least one server 110 having a processor 112 and a memory 114, the memory 114 including a database 116 storing a plurality of user-profiles 111 and a plurality of merchant-profiles 113. Further, the memory 114 may include computer readable instructions 115 executable by the processor 112. In addition to this, the social network system 100 may include a software application 120 downloadable to an electronic-device 5, the electronic-device 5 being equipped with global positioning means 10.

When the processor 112 executes the computer readable instructions 115, the processor 112 may be triggered to receive a merchant search request via the software application 120; determine a location of a user of the software application 120 via the global positioning means 10 read by the electronic-device 5; determine nearby merchants 117 from the plurality of merchant-profiles 113 based on the location of the user and generate a list of nearby merchant-profiles, each of the nearby merchants 117 being associated with a geofence threshold; and determine nearby users 118 from the plurality of user-profiles 111 that are located within the geofence threshold for each of the nearby merchants 117 and generate at least one list of nearby user-profiles.

The respective locations of each of the nearby users 118 may be determined via a position of each mobile-device of each said nearby user relative to the geofence threshold of each of the nearby merchants 117. Preferably, the processor 112 may be configured to repeatedly check for an updated location of the location of each of the nearby users 118 and update the list of nearby user-profiles based on the updated location of each of the nearby users 118 such that the user of the software application 120 is able to view exactly who is at the merchants establishment in real time. In one embodiment, the processor 112 may be configured to repeatedly determine a capacity of each of the nearby merchants 117 based on the location of the nearby users 118. For example, if the processor 112 determines that 12 customers are within the geofence threshold of “pub and eatery”, the software application 120 will show the capacity of “pub and eatery” as 12.

Further, the list of the nearby merchant-profiles may be ordered based on the capacity of each of the nearby merchants 117. For example, if the capacity of “pub and eatery” is 12, and the capacity of “tavern” is 25, “tavern” will be placed above “pub and eatery” in the list. Preferably, each of the nearby user-profiles of the nearby users 118 may be displayed on the electronic device as being within the nearby merchant-profile of the nearby merchant in which the nearby user is located within the geofence threshold of. For example, if the user selects “pub and eatery” from the list, they may be able to view the nearby user profiles of the nearby users 118 currently in the geofence threshold of “pub and eatery”.

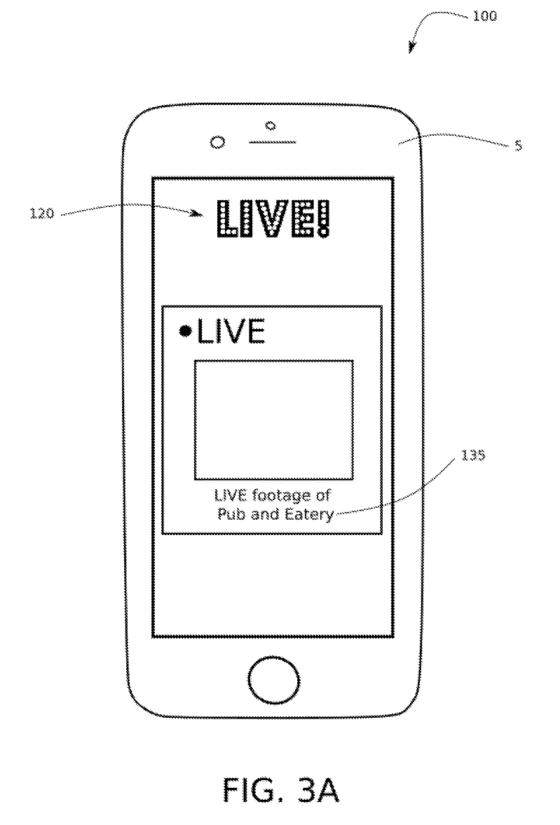

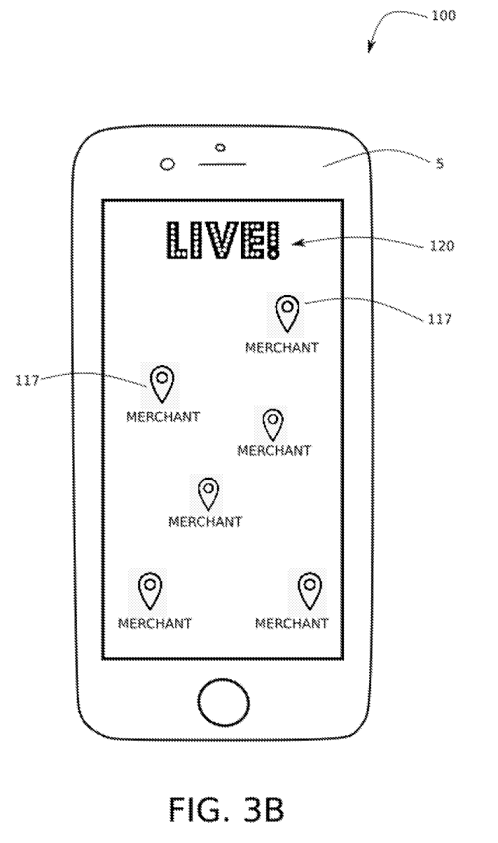

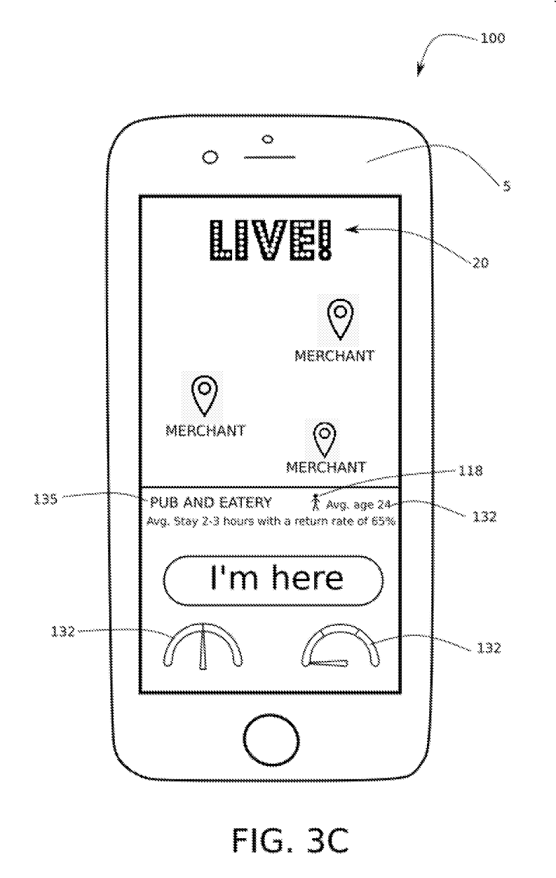

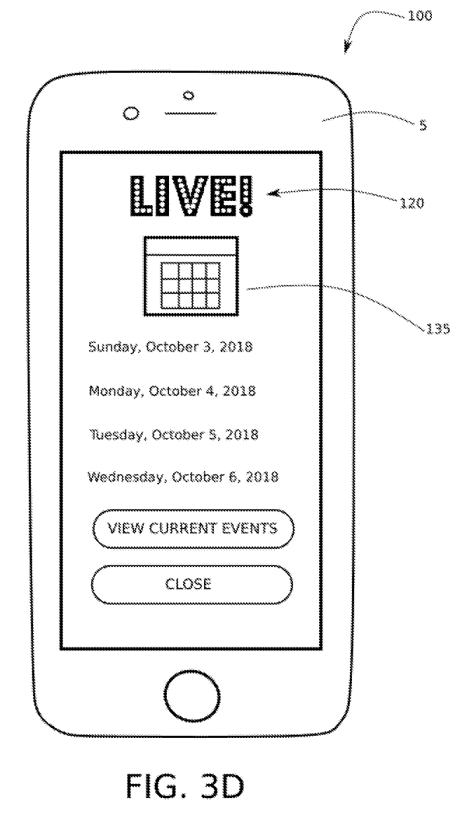

FIGS. 3A-3D show a front perspective view of the social network system and method 100 of FIG. 1, according to an embodiment of the present disclosure. Each of the merchant-profiles may include merchant information 135. Merchant information 135 may include information such as the name of the merchant, the type of merchant (bar, restaurant, store, mall, etc.), music, location shown on a map, reviews, ratings, photos, etc. In particular, the merchant information 135 may include event information 136. The event information 136 may show past events, current events and future events. Further to this, the user may be able to view a livestream of the inside of the merchant which would allow the user to view any current events, and also view the atmosphere, capacity, etc. of the merchants' establishment. To achieve this, the processor 112 may be configured to receive a live video stream from a merchant-unit, process the live video stream, and distribute the live video stream for real time live broadcasting of the live video stream on the electronic device (via the software application 120).

As discussed above, each of the nearby user-profiles of the nearby users 118 may be displayed on the electronic device as being within the nearby merchant-profile of the nearby merchant in which the nearby user is located within the geofence threshold of. Each of the user-profiles may include demographical information 132. In this embodiment, the user may be able to click on the nearby merchant-profile and view demographical information 132 about the nearby users 118 of the merchant. Examples of demographical information 132 collected by the social network system 100 may include age information 133, gender information 134, music taste information, etc.

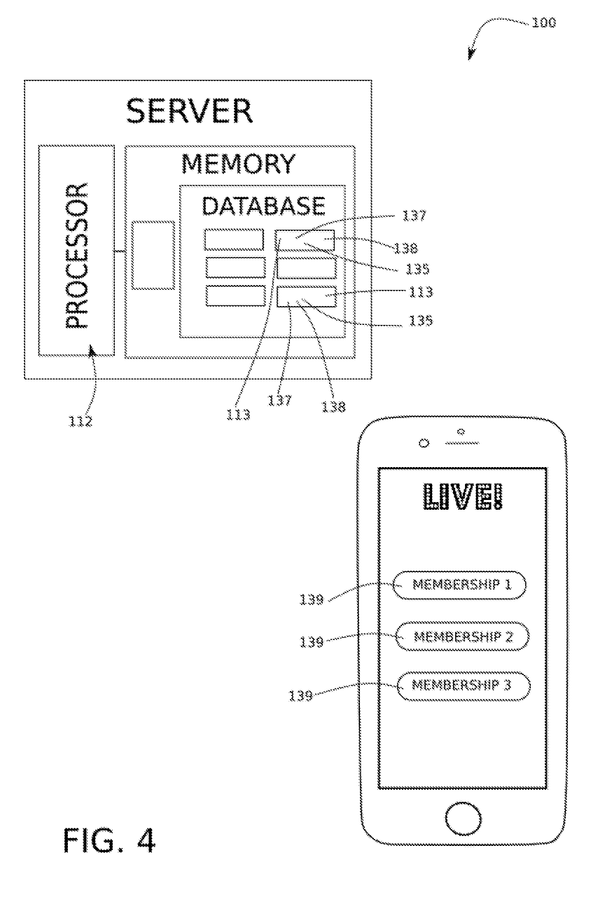

FIG. 4 shows a front perspective view of the social network system and method 100 of FIG. 1, according to an embodiment of the present disclosure. As shown, the merchant information 135 may also include membership information 137. Preferably, the membership information 137 may include subscription information 138 which includes at least three membership-tiers 139. Each of the plurality of merchant-profiles 113 may be associated with one of the at least three membership-tiers 139 and may pay a subscription fee based on their level. Due to this, the subscription information 138 may further include payment information. The processor 112 may be configured to initiate a payment on a pre-determined basis from the payment information based on the one of that least three membership-tiers 139. For example, the processor 112 may be configured to initiate payment weekly, bi-weekly, monthly, yearly, etc. This may occur on a set date, or an anniversary date of which the merchant originally signed up for the subscription.

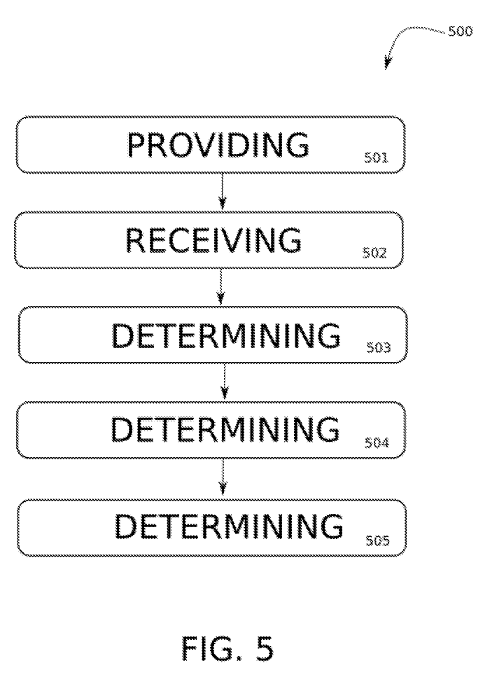

FIG. 5 is a flow diagram illustrating a method 500, according to an embodiment of the present disclosure. As illustrated, the method 500 may include the steps of: step one 501, providing a social network system 100; step two 502, receiving a merchant search request via the software application 120, step three 503, determining a location of a user of the software application 120 via the global positioning means 10 read by the electronic-device 5; step four 504, determining nearby merchants 117 from the plurality of merchant-profiles 113 based on the location of the user and generating a list of nearby merchant-profiles, each of the nearby merchants 117 being associated with a geofence threshold; and step five 505, determining nearby users 118 from the plurality of user-profiles 111 that are located within the geofence threshold for each of the nearby merchants 117 and generating at least one list of nearby user-profiles.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for social network system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A social network system and method for facilitating merchant searching and gaining live feedback, the method comprising the steps of:
providing a social network system including:
at least one server having a processor and a memory, the memory including a database storing a plurality of user-profiles and a plurality of merchant-profiles, the memory further including computer readable instructions executable by the processor; and
a software application downloadable to an electronic-device, the electronic-device being equipped with global positioning means;
receiving a merchant search request via the software application;
determining a location of a user of the software application via the global positioning means read by the electronic-device;
determining nearby merchants from the plurality of merchant-profiles based on the location of the user and generating a list of nearby merchant-profiles, each of the nearby merchants being associated with a geofence threshold;
determining nearby users from the plurality of user-profiles that are located within the geofence threshold for each of the nearby merchants and generating at least one list of nearby user-profiles.

2. The method of claim 1, wherein respective said locations of each of the nearby users are determined via a position of each mobile-device of each said nearby user relative to the geofence threshold of each of the nearby merchants.

3. The method of claim 1, wherein the processor is configured to repeatedly check for an updated location of the location of each of the nearby users.

4. The method of claim 3, wherein the processor is configured to update the list of nearby user-profiles based on the updated location of each of the nearby users.

5. The method of claim 1, wherein the processor is configured to repeatedly determine a capacity of each of the nearby merchants based on the location of the nearby users.

6. The method of claim 5, wherein the list of the nearby merchant-profiles is ordered based on the capacity of each of the nearby merchants.

7. The method of claim 1, wherein each of the nearby user-profiles of the nearby users are displayed on the electronic device as being within the nearby merchant-profile of the nearby merchant in which the nearby user is located within the geofence threshold of.

8. The method of claim 1, wherein each of the user-profiles includes demographical information.

9. The method of claim 8, wherein the demographical information includes age information.

10. The method of claim 9, wherein the demographical information includes gender information.

11. The method of claim 1, wherein each of the merchant-profiles includes merchant information.

12. The method of claim 11, wherein the merchant information includes event information.

13. The method of claim 12, wherein the merchant information includes membership information.

14. The method of claim 13, wherein the membership information includes subscription information, and wherein the subscription information includes at least three membership-tiers.

15. The method of claim 14, wherein the subscription information further includes payment information.

16. The method of claim 14, wherein each of the plurality of merchant-profiles is associated with one of the at least three membership-tiers.

17. The method of claim 16, wherein the processor is configured to initiate a payment on a pre-determined basis from the payment information based on the one of that least three membership-tiers.

18. The method of claim 1, wherein the processor is configured to receive a live video stream from a merchant-unit, process the live video stream, and distribute the live video stream for real time live broadcasting of the live video stream on the electronic device.

19. A social network system and method for facilitating merchant searching and gaining live feedback, the method comprising the steps of:
providing a social network system including:
at least one server having a processor and a memory, the memory including a database storing a plurality of user-profiles and a plurality of merchant-profiles, the memory further including computer readable instructions executable by the processor; and
a software application downloadable to an electronic-device, the electronic-device being equipped with global positioning means;
receiving a merchant search request via the software application;
determining a location of a user of the software application via the global positioning means read by the electronic-device;
determining nearby merchants from the plurality of merchant-profiles based on the location of the user and generating a list of nearby merchant-profiles, each of the nearby merchants being associated with a geofence threshold;
determining nearby users from the plurality of user-profiles that are located within the geofence threshold for each of the nearby merchants and generating at least one list of nearby user-profiles; and
wherein the processor is configured to receive a live video stream from a merchant-unit, process the live video stream, and distribute the live video stream for real time live broadcasting of the live video stream on the electronic device; and
wherein the location of each of the nearby users are determined via a position of each respective said mobile-device of each nearby user relative to the geofence threshold of each of the nearby merchants;
wherein the processor is configured to repeatedly check for an updated location of the location of each of the nearby users;
wherein the processor is configured to update the list of nearby user-profiles based on the updated location of each of the nearby users;
wherein the processor is configured to repeatedly determine a capacity of each of the nearby merchants based on the location of the nearby users;
wherein each of the nearby user-profiles of the nearby users are displayed on the electronic device as being within the nearby merchant-profile of the nearby merchant in which the nearby user is located within the geofence threshold of;
wherein each of the user-profiles includes demographical information;
wherein the merchant information includes membership information;
wherein the membership information includes subscription information, and wherein the subscription information includes at least three membership-tiers; and
wherein each of the plurality of merchant-profiles is associated with one of the at least three membership-tiers.

20. A social network system for facilitating business searching and gaining live feedback, the social network system comprising:
at least one server having a processor and a memory, the memory including a database storing a plurality of user-profiles and a plurality of merchant-profiles, the memory further including computer readable instructions executable by the processor that when executed by the processor trigger the processor to:
receive a merchant search request via the software application;
determine a location of a user of the software application via the global positioning means read by the electronic-device;
determine nearby merchants from the plurality of merchant-profiles based on the location of the user and generate a list of nearby merchant-profiles, each of the nearby merchants being associated with a geofence threshold;
determine nearby users from the plurality of user-profiles that are located within the geofence threshold for each of the nearby merchants and generate at least one list of nearby user-profiles; and
a software application downloadable to an electronic-device, the electronic-device being equipped with global positioning means.
